(19) United States
(12) Patent Application Publication
(10) Pub. No.: US 2023/0057420 A1
(43) Pub. Date: Feb. 23, 2023

(54) ION EXCHANGE MEMBRANE, MEMBRANE ELECTRODE ASSEMBLY, FUEL CELL, REDOX FLOW SECONDARY BATTERY, WATER ELECTROLYZER, AND ELECTROLYZER FOR ORGANIC HYDRIDE SYNTHESIS

(71) Applicant: ASAHI KASEI KABUSHIKI KAISHA, Tokyo (JP)

(72) Inventor: Junya YAMASHITA, Tokyo (JP)

(73) Assignee: ASAHI KASEI KABUSHIKI KAISHA, Tokyo (JP)

(21) Appl. No.: 17/882,846

(22) Filed: Aug. 8, 2022

(30) Foreign Application Priority Data
Aug. 11, 2021 (JP) 2021-131220
Jun. 13, 2022 (JP) 2022-095231

(51) Int. Cl. H01M 8/106; H01M 8/1004; H01M 8/1023; H01M 8/1039; H01M 8/1062; H01M 8/18; C25B 13/05; C25B 13/08; C25B 9/23; C25B 1/04; C25B 3/01

(52) U.S. Cl. CPC H01M 8/106; H01M 8/1004; H01M 8/1023; H01M 8/1039; H01M 8/1062; H01M 8/188; C25B 13/05; C25B 13/08; C25B 9/23; C25B 1/04; C25B 3/01; H01M 2008/1095

(57) ABSTRACT

Provided are an ion exchange membrane that has excellent mechanical strength as well as can exhibit an excellent proton conductivity over a long period, a membrane electrode assembly, a fuel cell, a redox flow secondary battery, a water electrolyzer, and an electrolyzer for organic hydride synthesis.

An ion exchange membrane containing:

an electrolyte containing a perfluorocarbon sulfonic acid polymer; and

glass fiber having a SiO₂ content of 99.9% by mass or more.

### TECHNICAL FIELD

The present invention relates to an ion exchange membrane, a membrane electrode assembly, a fuel cell, a redox flow secondary battery, a water electrolyzer, and an electrolyzer for organic hydride synthesis.

### BACKGROUND ART

Fuel cells, which are power generating devices that extract electric energy by electrochemically oxidizing fuels such as hydrogen and methanol, have attracted attention as clean energy supply sources. Particularly, solid polymer electrolyte fuel cells operate at lower temperatures than other types of fuel cells and thus are used as alternative power sources for automobiles and power sources for household cogeneration systems.

The basic structure of a solid polymer electrolyte fuel cell is composed of a solid polymer electrolyte membrane and a pair of gas diffusion electrodes bonded onto both the sides thereof. In the structure, hydrogen is supplied to one electrode, oxygen is supplied to the other electrode, and an external load circuit is connected between both the electrodes to thereby generate power. More specifically, protons and electrons are generated at the hydrogen-side electrode. The protons move inside the solid polymer electrolyte membrane to reach the oxygen-side electrode, and then react with oxygen to generate water. Meanwhile, from the electrons that flowed out through the conducting wire from the hydrogen-side electrode, electric energy is extracted in the external load circuit. Thereafter, the electrons further move through the conducting wire to reach the oxygen-side electrode, contributing to the progress of the water generation reaction.

Examples of properties required from solid polymer electrolyte membranes include ion conductivity, high water content, water dispersibility, low permeability to gas, chemical stability to withstand a highly oxidizing atmosphere during fuel cell operation, and mechanical strength.

As materials used in solid polymer electrolyte membranes that are used in solid polymer electrolyte fuel cells, fluorine ion exchange resins are widely used. Particularly widely used is “Nafion (R)” manufactured by Dupont-de-Nemours Inc., which has a main chain comprising perfluorocarbon, and has a sulfonic acid group at the end of a side chain. Such a fluorine ion exchange resin has generally balanced properties for a solid polymer electrolyte material. However, as practical use of the batteries progresses, higher durability has been demanded.

For example, Patent Literature 1 has suggested that a glass composition containing components: 60≤SiO₂≤75, 0.1≤(MgO+CaO)≤20, 6≤Na₂O≤15, 9≤(Li₂O+Na₂O+K₂O)≤15, and 5.1≤ZrO₂≤9.9, expressed in terms of percent by mass, is used in glass fiber for reinforcing the solid electrolyte membrane of a solid polymer fuel cell. The glass composition is said to combine high acid resistance and high water resistance.

### CITATION LIST

### Patent Literature

[Patent Literature 1] Japanese Patent Laid-Open No. 2016-204230

### SUMMARY OF INVENTION

### Technical Problem

According to the investigations of the present inventors, when the glass composition described in Patent Literature 1 is used in glass fiber for reinforcing an ion exchange membrane, mechanical strength derived from the reinforcing material may be imparted. However, the other metal components contained in a significant amount in the glass fiber are likely to be eluted, the eluted metal ions are believed to be subjected to ion exchange with sulfonic acid groups in the membrane, and consequently, the proton conductivity tends to decrease. As described above, the techniques described in Patent Literature 1 still leave room for improvement, from the viewpoint of achieving an ion exchange membrane that has excellent mechanical strength as well as can exhibit an excellent proton conductivity over a long period.

The present invention has been made in view of the above problem, and it is an object of the present invention to provide an ion exchange membrane that has excellent mechanical strength as well as can exhibit an excellent proton conductivity over a long period, a membrane electrode assembly, a fuel cell, a redox flow secondary battery, a water electrolyzer, and an electrolyzer for organic hydride synthesis.

### Solution to Problem

The present inventors have found that the problem described above can be solved by adjusting the SiO₂ content in glass fiber to be combined with the electrolyte, thereby having completed the present invention.

More specifically, the present invention includes the following aspects.

[1]

An ion exchange membrane comprising:

an electrolyte comprising a perfluorocarbon sulfonic acid polymer; and

glass fiber having a SiO₂ content of 99.9% by mass or more.

[2]

The ion exchange membrane according to [1], wherein a basis weight of the glass fiber is from 3.0 to 15 g/m².

[3]

The ion exchange membrane according to [1] or [2], wherein a fiber diameter of the glass fiber is from 1 to 10 μm.

[4]

The ion exchange membrane according to any of [1] to [3], wherein a Tex count of the glass fiber is from 0.05 to 10 Tex.

[5]

A membrane electrode assembly comprising the ion exchange membrane according to any of [1] to [4], and a catalyst layer disposed on at least one side of the ion exchange membrane.

[6]

A fuel cell comprising the membrane electrode assembly according to [5].

[7]

A redox flow secondary battery comprising the ion exchange membrane according to any of [1] to [4].

[8]

A water electrolyzer comprising the ion exchange membrane according to any of [1] to [4].

[9]

An electrolyzer for organic hydride synthesis comprising the ion exchange membrane according to any of [1] to [4].

### Advantageous Effect of Invention

According to the present invention, it is possible to provide an ion exchange membrane that has excellent mechanical strength as well as can exhibit an excellent proton conductivity over a long period, a membrane electrode assembly, a fuel cell, a redox flow secondary battery, a water electrolyzer, and an electrolyzer for organic hydride synthesis.

### DESCRIPTION OF EMBODIMENT

Hereinbelow an embodiment for carrying out the present invention (hereinbelow, referred to simply as “the present embodiment”) will be described in detail. The following present embodiment is by way of illustration for describing the present invention and is not intended to limit the present invention to the following content. The present invention may be appropriately modified and carried out within the spirit thereof.

### <Ion Exchange Membrane>

An ion exchange membrane of the present embodiment comprises an electrolyte containing a perfluorocarbon sulfonic acid polymer, and glass fiber having a SiO₂ content of 99.9% by mass or more. The ion exchange membrane of the present embodiment, as being thus configured, has excellent mechanical strength as well as can exhibit an excellent proton conductivity over a long period.

### [Electrolyte]

An electrolyte in the present embodiment contains a perfluorocarbon sulfonic acid polymer (hereinbelow, also referred to as the “PFSA”) from the viewpoint of suppressing voids in the ion exchange membrane.

The PFSA in the present embodiment is not particularly limited, and from the viewpoint of durability and performance, preferable is one obtained by hydrolysis of a perfluorocarbon sulfonic acid resin precursor comprising a copolymer of a fluorinated vinyl ether compound represented by the following general formula (1) and a fluorinated olefin monomer represented by the following general formula (2):)

CF₂═CF—O—(CF₂CFXO)ₙ—(CF₂)ₘ—W (1)

wherein X is F or a perfluoroalkyl group having 1 to 3 carbon atoms, n is an integer of 0 to 5, m is an integer of 0 to 12; provided that n and m are not 0 at the same time, and W is a functional group that may be converted to SO₃H by hydrolysis;

CF₂═CFZ (2)

wherein Z is H, Cl, F or a perfluoroalkyl group having 1 to 3 carbon atoms.

The functional group that may be converted to SO₃H by hydrolysis is not particularly limited, and SO₂F, SO₂Cl, or SO₂Br is preferable. Preferable are perfluorocarbon sulfonic acid resin precursors in which X═CF₃, W═SO₂F, and Z═F in the above formulas. Of these, ones in which n=0, m=an integer of 1 to 6, X═CF₃, W═SO₂F, and Z═F are further preferable because a solution having a high concentration tends be obtained.

The perfluorocarbon sulfonic acid resin precursor as described above can be synthesized by a known means. For example, there are known a method in which the above-described fluorinated vinyl compound and a gas of a fluorinated olefin are filled, dissolved using a polymerization solvent such as a fluorine-containing hydrocarbon, and polymerized by a reaction (solution polymerization), a method in which a fluorinated vinyl compound per se is used as a polymerization solvent and polymerized without use of a solvent such as a fluorine-containing hydrocarbon (mass polymerization), a method in which a fluorinated vinyl compound and a gas of a fluorinated olefin are filled and polymerized by a reaction using an aqueous solution of a surfactant as a medium (emulsion polymerization), a method in which a fluorinated vinyl compound and a gas of a fluorinated olefin are filled and emulsified in an aqueous solution of an emulsion aid such as a surfactant and an alcohol and polymerized by a reaction (miniemulsion polymerization, microemulsion polymerization), a method in which a fluorinated vinyl compound and a gas of a fluorinated olefin are filled and suspended in an aqueous solution of a suspension stabilizer and polymerized by a reaction (suspension polymerization), and the like. In the present embodiment, precursors synthesized by any of the polymerization methods can be used.

As the fluorine-containing hydrocarbon to be used as a polymerization solvent of the solution polymerization, for example, a group of compounds collectively referred to as “Freon (R)” is suitably used, such as trichlorotrifluoroethane and 1, 1, 1, 2, 3, 4, 4, 5, 5, 5-decafluoropentane.

The perfluorocarbon sulfonic acid resin precursor produced as described above is extruded with a nozzle, die or the like using an extruder. The forming method and the shape of the formed product in this case are not particularly limited. From the viewpoint of a higher treatment rate in the hydrolysis treatment and an acid treatment mentioned below, the formed product is preferably in the form of pellets of 0.5 cm³ or less.

The perfluorocarbon sulfonic acid resin precursor formed as described above is then immersed in a basic reaction liquid and subjected to a hydrolysis treatment.

The reaction liquid used in this hydrolysis treatment is not particularly limited. Aqueous solutions of an amine compound such as dimethylamine, diethylamine, monomethylamine, or monoethylamine or aqueous solutions of a hydroxide of an alkali metal or alkaline earth metal are preferable, and sodium hydroxide and potassium hydroxide are particularly preferable. The content of the alkali metal or alkaline earth metal in the aqueous solution of a hydroxide is preferably, but not particularly limited to, from 10 to 30% by mass. The reaction liquid described above more preferably contains additionally a swellable organic compound such as methyl alcohol, ethyl alcohol, acetone, and DMSO. The content of the swellable organic compound in the aqueous solution is preferably from 1 to 30% by mass.

The treatment temperature in the hydrolysis treatment depends on the solvent type, solvent composition and the like, and with a higher treatment temperature, the treatment period can be made shorter. However, with an excessively high treatment temperature, the perfluorocarbon sulfonic acid resin precursor is dissolved or highly swelled, becoming difficult to handle. Thus, the treatment is performed preferably at 20 to 160° C., more preferably at 40 to 90° C. For achieving a higher conductivity, all the functional groups that may be converted into SO₃H by hydrolysis are preferably subjected to a hydrolysis treatment. Thus, a longer treatment period is more preferable. However, an excessive long treatment period causes the productivity to decrease. Thus, the treatment period is preferably from 0.1 to 48 hours, more preferably from 0.2 to 12 hours.

The perfluorocarbon sulfonic acid resin precursor is subjected to a hydrolysis treatment in the basic reaction liquid, then sufficiently water-washed with warm water or the like, and subjected to an acid treatment. An acid used for the acid treatment is not particularly limited. Mineral acids such as hydrochloric acid, sulfuric acid, and nitric acid and organic acids such as oxalic acid, acetic acid, formic acid, and trifluoroacetic acid are preferable, and mixtures of these acids and water are more preferable. The acids described above may be used in combination of two or more. This acid treatment protonates the perfluorocarbon sulfonic acid resin precursor into a SO₃H form. The PFSA obtained by protonation is enabled to be dissolved in a protic organic solvent, water, or a mixed solvent from both of them.

A particularly preferable PFSA is a copolymer comprising a repeating unit represented by —(CF₂—CF₂)— and a repeating unit represented by —(CF₂—CF(—O—(CF₂CFXO)ₙ—(CF₂)ₘ—SO₃H))—, wherein X is F or CF₃, n is an integer of 0 to 5, and m is an integer of 0 to 12; provided that n and m are not 0 at the same time.

### (Ion Equivalent)

The ion equivalent of the electrolyte is preferably from 400 to 1800 geq⁻¹, more preferably from 500 to 1600 geq⁻¹, further preferably from 600 to 1200 geq⁻¹, from the viewpoint of stable operation and power generating performance at high temperatures and high humidification. The ion equivalent described above can be measured based on a method described in Examples mentioned below, and can be within the range described above by appropriately adjusting the composition of the electrolyte, for example.

### (Density of Electrolyte)

The density of the electrolyte depends on the proportions of the hydrophobic phase and hydrophilic phase in the PFSA, and with a higher proportion of the hydrophobic phase, the density increases. Thus, from the viewpoint of achieving both the proton conductivity and mechanical strength at a high level, the density is preferably from 1.95 to 2.18 gcm⁻³, more preferably from 1.98 to 2.15 gcm⁻³, further preferably from 2.00 to 2.12 gcm⁻³. The density described above can be measured based on a method described in Examples mentioned below, and can be within the range described above by appropriately adjusting the composition of the electrolyte, for example.

### (Volume Fraction of Electrolyte)

The volume fraction of the electrolyte should be large from the view point of proton conductivity. Meanwhile, from the viewpoint of the mechanical strength of the membrane, it is inevitable to contain a reinforcing material at a certain volume fraction or higher. Accordingly, from the viewpoint of satisfying the both at a high level, the volume fraction is preferably from 80 to 90 vol %, more preferably from 85 to 92 vol %, further preferably from 88 to 90 vol %. The volume fraction described above can be measured based on a method described in Examples mentioned below.

### (Other Electrolytes)

In addition to those mentioned above, the electrolyte in the present embodiment may contain a hydrocarbon proton exchange resin, for example. Examples of the hydrocarbon proton exchange resin include, but not particularly limited to, sulfonated aromatic polymers and polybenzimidazole, as described in Japanese Patent Laid-Open No. 2006-139934 and Chem. Rev. 104(2004) 4587-4612.

### [Glass Fiber]

The glass fiber in the present embodiment has a SiO₂ content of 99.9% by mass or more from the viewpoint of prevention of a decrease in the proton conductivity over time. In this respect, the present inventors make a presumption as follows. Specifically, the glass fiber in the present embodiment is made to have a content of other components such as metal of 0.1% by mass or less, and thus, elution of the metal component is significantly suppressed. Consequently, as ion exchange of the sulfonic acid group by metal ions can be suppressed, a decrease in the proton conductivity over time can be prevented. However, the action mechanism in the present embodiment is not intended to be limited to the description above.

### (Basis Weight of Glass Fiber)

The basis weight of the glass fiber is preferably from 3.0 g/m² to 15 g/m², more preferably from 5.0 to 12 g/m², further preferably from 7.0 to 10 g/m², from the viewpoint of achieving both the mechanical strength and proton conductivity. When the basis weight described above is 3.0 g/m² or more, there is a tendency that the strength derived from the glass fiber can be sufficiently achieved. When the basis weight described above is 15 g/m² or less, there is a tendency that the proton conductivity can be sufficiently achieved. The basis weight described above can be measured based on a method described in Examples mentioned below, and can be within the range described above by appropriately selecting the fiber diameter of glass fiber to be used, the number of filaments of the warp yarn and weft yarn, and the weaving method, for example.

### (Fiber Diameter of Glass Fiber)

The fiber diameter of the glass fiber is preferably from 1 μm to 10 μm, more preferably from 2 to 8 μm, further preferably from 2 to 6 μm, from the viewpoint of achieving both the mechanical strength and proton conductivity. When the fiber diameter described above is 1 μm or more, an excessive increase in the volume fraction of voids in the ion exchange membrane can be prevented, and as a result, the proton conductivity tends to increase. When the fiber diameter described above is 10 μm or less, there is a tendency that the strength derived from the glass fiber can be sufficiently achieved. The fiber diameter described above can be measured based on a method described in Examples mentioned below. The fiber diameter described above can be within the range described above by appropriately adjusting conditions in a spinning step for producing glass fiber bundles, for example.

### (Tex Count of Glass Fiber)

The Tex count of the glass fiber (unit: Tex) is the mass of fiber per 1000 m, expressed as a value in units of grams. The Tex count is preferably 0.05 Tex or more and 10 Tex or less, more preferably 0.25 Tex or more and 5 Tex or less, further preferably 0.5 Tex or more and 2.5 Tex or less, from the viewpoint of achieving both the mechanical strength and proton conductivity. When the Tex count described above is 0.05 Tex or more, an excessive increase in the volume fraction of voids in the ion exchange membrane can be prevented, and as a result, the proton conductivity tends to increase. When the Tex count described above is 10 Tex or less, there is a tendency that the strength derived from the glass fiber can be sufficiently achieved. The Tex count described above can be measured based on a method described in Examples mentioned below. The Tex count described above can be within the range described above by appropriately adjusting conditions in a spinning step for producing glass fiber bundles, for example.

### (Density of Glass Fiber)

The density of the glass fiber is preferably from 2.18 to 2.60 gcm⁻³, more preferably from 2.19 to 2.45 gcm⁻³, further preferably from 2.20 to 2.30 gcm⁻³, from the viewpoint of achieving both the mechanical strength and proton conductivity. The density described above can be measured based on a method described in Examples mentioned below, and can be within the range described above by a high-temperature high-pressure treatment, neutron beam irradiation, or the like, for example.

### (Volume Fraction of Glass Fiber)

The volume fraction of the glass fiber should be small from the viewpoint of proton conductivity. Meanwhile, from the viewpoint of the mechanical strength of the membrane, it is inevitable to have a volume fraction of a certain value or higher. Accordingly, from the viewpoint of satisfying the both at a high level, the volume fraction is preferably from 3 to 20 vol %, more preferably from 5 to 15 vol %, further preferably from 8 to 12 vol %. The volume fraction described above can be measured based on a method described in Examples mentioned below.

### (Form of Glass Fiber)

The form of the glass fiber is not particularly limited, and plain-woven, twill-woven, satin-woven fabrics, and the like can be preferably used. The thickness of the woven fabric also is not particularly limited, and is preferably from 5 to 20 μm. The thickness described above can be measured based on a method described in Examples mentioned below.

### [Physical Properties of Ion Exchange Membrane]

### (Basis Weight of Ion Exchange Membrane)

The basis weight of the ion exchange membrane is preferably from 10 g/m² to 400 g/m², more preferably from 20 to 300 g/m², further preferably from 30 to 200 g/m², from the viewpoint of achieving both the mechanical strength and proton conductivity. The basis weight described above can be measured based on a method described in Examples mentioned below, and can be within the range described above by appropriately selecting the thickness of the PFSA and the glass fiber woven fabric to be used, for example.

### (Density of Ion Exchange Membrane)

The density of the ion exchange membrane is preferably from 2.00 to 2.20 gcm⁻³, more preferably from 2.03 to 2.17 gcm⁻³, further preferably from 2.05 to 2.15 gcm⁻³, from the viewpoint of achieving both the mechanical strength and proton conductivity. The density described above can be measured based on a method described in Examples mentioned below, and can be within the range described above by appropriately selecting the PFSA and glass fiber woven fabric to be used, for example.

### (Volume Fraction of Voids)

The volume fraction of voids in the ion exchange membrane is preferably from 0.1 to 2.0 vol %, more preferably from 0.2 to 1.5 vol %, further preferably from 0.3 to 1.0 vol %, from the viewpoint of achieving both the mechanical strength and proton conductivity. The volume fraction described above can be measured based on a method described in Examples mentioned below, and can be within the range described above by appropriately selecting the solvent for the PFSA solution with which the glass fiber woven fabric is impregnated and the glass fiber to be used, for example.

### (Thickness of Ion Exchange Membrane)

The thickness of the ion exchange membrane is not particularly limited, and is preferably from 10 to 250 μm. The thickness described above can be measured based on a method described in Examples mentioned below.

### <Method for Producing Ion Exchange Membrane>

Next, the method for producing the ion exchange membrane of the present embodiment will be described in detail. The ion exchange membrane of the present embodiment can be obtained by impregnating the glass fiber with an electrolyte.

The method for impregnating the glass fiber with an electrolyte is not particularly limited, and examples thereof include a method in which the glass fiber is coated with an electrolyte mentioned below and a method in which the glass fiber is immersed in a solution containing an electrolyte (electrolyte solution) followed by drying. An example thereof is a method including forming a film derived from an electrolyte solution on an elongate casting substrate (sheet) that is moving or being left to stand, bringing elongate glass fiber into contact with the solution to form an unfinished composite structure, drying this unfinished composite structure in a hot-air circulating chamber or the like, and then forming another film of the electrolyte solution on the dried unfinished composite structure to produce an ion exchange membrane. The contact between the electrolyte solution and the glass fiber may be made in a dried state, undried state, or wet state. The contact may be made while press-bonding is performed with a rubber roller, the tension of the glass fiber is controlled, or the like. Further, filling may be performed by preliminarily forming a sheet containing an electrolyte by extrusion, casting, or the like and placing the glass fibers on this sheet followed by thermal-pressing.

The ion exchange membrane thus produced as is may be used as the ion exchange membrane of the present embodiment. Further, in order to improve the conductivity of the electrolyte and the mechanical strength, one or more layers containing the electrolyte may be separately layered on at least one main surface of the electrolyte membrane. In addition to or instead of the operation described above, a crosslinking agent, ultraviolet rays, electron beams, radiation, or the like may be used to the ion exchange membrane to thereby crosslink the compounds contained therein.

The ion exchange membrane subjected to the treatment mentioned above may also be used as the ion exchange membrane of the present embodiment.

The ion exchange membrane obtainable as mentioned above is preferably further subjected to a thermal treatment. This thermal treatment causes a crystalline substance portion and an electrolyte potion in the ion exchange membrane to firmly adhere to each other, and as a result, the mechanical strength may be stabilized. The temperature for this thermal treatment is preferably from 100° C. to 230° C., more preferably from 110° C. to 230° C., further preferably from 120° C. to 200° C. When the temperature for the thermal treatment is adjusted within the range described above, adhesion between the crystalline substance portion and the electrolyte portion tends to increase. Also from the viewpoint of keeping the water content and mechanical strength of the ion exchange membrane at a high level, the temperature range described above is suitable. The period of the thermal treatment, which depends on the temperature for the thermal treatment, is preferably from 5 minutes to 3 hours, more preferably from 10 minutes to 2 hours, from the viewpoint of obtaining an ion exchange membrane having high durability.

### (Electrolyte Solution)

An electrolyte solution that can be used for producing the ion exchange membrane of the present embodiment comprises the electrolyte and solvent in the present embodiment, and other additives as required. This electrolyte solution, as is or after subjected to steps such as filtration and concentration, is used for impregnation of the glass fiber. Such electrolyte solutions may be used singly or in combination of a plurality thereof.

A method for producing the electrolyte solution is not particularly limited. For example, the electrolyte is dissolved or dispersed in a solvent to obtain a solution, and then additives are dispersed in the solution as required. Alternatively, first, the electrolyte is melt-extruded and subjected to a step such as extension to mix the electrolyte with additives, and the mixture is dissolved or dispersed in a solvent. In this manner, the electrolyte solution can be obtained.

More specifically, first, a formed product from a polymer as a precursor of the electrolyte (precursor polymer) is immersed in a basic reaction liquid and hydrolyzed. This hydrolysis treatment converts the precursor polymer to an electrolyte. Next, the above-described formed product after hydrolysis treatment is sufficiently water-washed with warm water or the like, and then, the formed product is subjected to an acid treatment. An acid used for the acid treatment is not particularly limited. Mineral acids such as hydrochloric acid, sulfuric acid, and nitric acid and organic acids such as oxalic acid, acetic acid, formic acid, and trifluoroacetic acid are preferable. This acid treatment protonates the precursor polymer, and the electrolyte, for example, a perfluorocarbon sulfonic acid polymer can be obtained.

The above-described formed product acid-treated as mentioned above (electrolyte-containing formed product) is dissolved or suspended in a solvent that may dissolve or suspend the electrolyte (solvent having a favorable affinity with the electrolyte). Examples of such solvents include protic organic solvents such as water, ethanol, methanol, n-propanol, isopropyl alcohol, butanol, and glycerin, and aprotic organic solvents such as N,N-dimethylformamide, N,N-dimethylacetamide, and N-methylpyrrolidone. These may be used singly or in combination of two or more. Particularly, when one solvent is used, the solvent is preferably water. When two or more solvents are used in combination, a mixed solvent of water and protic organic solvent is preferable.

A method for dissolving or suspending the electrolyte in a solvent is not particularly limited. For example, the electrolyte as is may be dissolved or dispersed in the solvent described above. Preferably, the electrolyte is dissolved or dispersed in the solvent under atmospheric pressure or under sealed and pressurized conditions by means of an autoclave or the like in the temperature range of 0 to 250° C. Particularly, when water and a protic organic solvent are used as the solvent, the mix ratio of water and the protic organic solvent can be appropriately selected in accordance with the dissolution method, dissolution conditions, the type of polymer electrolyte, the total solid concentration, the dissolution temperature, the stirring speed, and the like. The mass ratio of the protic organic solvent to water is preferably from 0.1 to 10 of the protic organic solvent to 1 of water, more preferably from 0.1 to 5 of the protic organic solvent to 1 of water.

In the electrolyte solution, there are included one or two or more of an emulsion (a liquid in which liquid particles are dispersed as colloidal particles or particles coarser than the colloidal particles to be emulsified), a suspension (a liquid in which solid particles are dispersed as colloidal particles or microscopically visible particles), a colloidal liquid (a state in which macromolecules are dispersed), a micellar liquid (a lyophilic colloid disperse system formed by association of many small molecules with an intermolecular forces), and the like.

The electrolyte solution can be concentrated or filtered in accordance with the forming method for the ion exchange membrane and its application. The method of concentration is not particularly limited, and examples thereof include a method of heating the electrolyte solution to evaporate the solvent and a method of concentration under reduced pressure. When the electrolyte solution is used as a coating solution, with an excessive high solid content of the electrolyte solution, there is a tendency that the viscosity increases and the solution becomes difficult to handle. In contrast, with an excessive low solid content thereof, the productivity tends to decrease. Thus, the solid content thereof is preferably from 0.5% by mass to 50% by mass. The method for filtering the electrolyte solution is not particularly limited, and typical examples include a method of pressure filtration using a filter. For the above filter, a filter medium whose 90% collected particle diameter is from 10 times to 100 times the average particle diameter of the solid particles included in the electrolyte solution is preferably used. Examples of the material of this filter medium include paper and metals. Particularly when the filter medium is paper, the 90% collected particle diameter is preferably from 10 times to 50 times the average particle diameter of the above-described solid particles. When a metal filter is used, the 90% collected particle diameter is preferably from 50 times to 100 times the average particle diameter of the above-described solid particles. Setting the 90% collected particle diameter at 10 times or more the average particle diameter may inhibit an excessive increase in the pressure required on feeding the liquid and inhibit clogging of the filter in a short period. On the other hand, setting the 90% collected particle diameter at 100 times or less the average particle diameter is preferable from the viewpoint of well removing aggregates of the particles and an undissolved resin, which may cause foreign matter in a film.

### <Membrane Electrode Assembly>

The ion exchange membrane of the present embodiment can be used in a variety of applications by use of the performance thereof. As one example thereof, the membrane can be used as a constituting member of a membrane electrode assembly (hereinbelow, also referred to as the “MEA”). In other words, the membrane electrode assembly of the present embodiment comprises the ion exchange membrane of the present embodiment and a catalyst layer disposed on at least one side of the ion exchange membrane. In the membrane electrode assembly of the present embodiment, typically, a catalyst layer that may function as an anode is disposed on one surface of the ion exchange membrane of the present embodiment, and a catalyst layer that may function as a cathode is disposed on the other surface thereof. In the membrane electrode assembly of the present embodiment, further typically, a pair of gas diffusion layers are disposed opposite to each other, further outside the catalyst layer. Such a structure may be also referred to as a MEA. The MEA of the present embodiment is only required to comprise the same configuration as that of a known MEA except for comprising the ion exchange membrane of the present embodiment.

The catalyst layers are each generally composed of fine particles of a catalyst metal and a conducting agent supporting the fine particles, and may contain a water repellent as required. The catalyst described above may be any metal that promotes oxidation of hydrogen and reduction of oxygen, and examples thereof include one or more selected from the group consisting of platinum, gold, silver, palladium, iridium, rhodium, ruthenium, iron, cobalt, nickel, chromium, tungsten, manganese, vanadium, and alloys thereof. Of these, platinum is mainly preferable.

As a method for producing the MEA, a known production method can be employed except that the ion exchange membrane of the present embodiment is used. An example of the method is as follows. First, platinum-supporting carbon as an electrode material is dispersed in a solution of an ion exchange resin, as a binder for the catalyst layer, dissolved in a mix solution of alcohol and water to give a paste. A certain amount of this paste is applied onto PTFE sheets and dried. Next, the applied surfaces of the PTFE sheets are opposed to each other, the ion exchange membrane is interposed therebetween and bonded by thermal-pressing at 100° C. to 200° C., and thus the MEA can be obtained. As the binder for the catalyst layer, a solution of a common ion exchange resin dissolved in a solvent (such as alcohol or water) is used. The electrolyte solution in the present embodiment also can be used, and from the viewpoint of durability, the electrolyte solution is preferable.

### <Fuel Cell>

The membrane electrode assembly (MEA) of the present embodiment can be a constituting member of a fuel cell. That is, the fuel cell of the present embodiment comprises the membrane electrode assembly of the present embodiment (MEA). Here, the MEA may be one that comprises the ion exchange membrane of the present embodiment and a catalyst layer disposed on at least one side of the ion exchange membrane, or a MEA having a structure in which optionally, additionally a pair of gas diffusion electrodes are opposed to each other, further outside the catalyst layer.

The fuel cell of the present embodiment is typically a solid polymer electrolyte fuel cell. The MEA of the present embodiment can be combined further with a constituent for use in common solid polymer electrolyte fuel cells, such as a bipolar plate or a bucking plate to constitute such a solid polymer electrolyte fuel cell. The solid polymer electrolyte fuel cell as above is only required to have the same configuration as that of a known one except that the MEA of the present embodiment is employed.

A bipolar plate means a plate made of a composite material of graphite and a resin, a metal, or the like, the plate having grooves formed on its surface for allowing gas such as fuels and an oxidant to flow. The bipolar plate has a function as a channel that supplies fuel and an oxidant to the vicinity of the catalyst layer, in addition to a function of transmitting electrons to an external load circuit. The MEA described above is inserted between such bipolar plates, and a plurality of the configurations thus formed are stacked to thereby produce the solid polymer electrolyte fuel cell according to the present embodiment.

The ion exchange membrane of the present embodiment, which has excellent mechanical strength as well as can exhibit an excellent proton conductivity over a long period, can be particularly preferably applied as a constituting member for a solid polymer electrolyte fuel cell.

### <Redox Flow Secondary Battery>

The ion exchange membrane of the present embodiment can be used in a variety of applications by use of the performance thereof. As one example of such applications, the membrane can be used as a constituting member of a redox flow secondary battery. That is, the redox flow secondary battery of the present embodiment comprises the ion exchange membrane of the present embodiment. The configuration of the redox flow secondary battery of the present embodiment is not particularly limited as long as the ion exchange membrane of the present embodiment is included, and is only required to have the same configuration as that of a known one except for the ion exchange membrane. The configuration is not limited to the following, and may be the same as that of International Publication No. WO 2020/184455, for example. Specifically, except that the ion exchange membrane of the present embodiment is employed instead of the electrolyte membrane for the redox flow battery described in the literature, the configuration described in the literature can be employed. More specifically, the redox flow battery of the present embodiment can comprise, for example, an electrolyzer comprising a positive electrode cell chamber comprising a positive electrode composed of a carbon electrode, a negative electrode cell chamber comprising a negative electrode composed of a carbon electrode, and the ion exchange membrane of the present embodiment as a membrane that separates the positive electrode cell chamber and the negative electrode cell chamber.

### <Water Electrolyzer>

The ion exchange membrane of the present embodiment can be used in a variety of applications by use of the performance thereof. As one example of such applications, the membrane can be used as a constituting member of a water electrolyzer. That is, the water electrolyzer of the present embodiment comprises the ion exchange membrane of the present embodiment. The configuration of the water electrolyzer of the present embodiment is not particularly limited as long as comprising the ion exchange membrane of the present embodiment, and is only required to have the same configuration as that of a known one except for the ion exchange membrane. The configuration is not limited to the following, and may be the same as that of International Publication No. WO 2019/088299, for example. Specifically, except that the ion exchange membrane of the present embodiment is employed as the solid polymer electrolyte membrane described in the literature, the configuration described in the literature can be employed. Specifically, the water electrolyzer of the present embodiment can comprise, for example, a hydrogen electrode to generate hydrogen, an oxygen electrode to generate oxygen, a hydrogen electrode chamber that encloses the hydrogen electrode and an electrolyte aqueous solution, an oxygen electrode chamber that encloses the oxygen electrode and an electrolyte aqueous solution, and the ion exchange membrane of the present embodiment as a solid polymer electrolyte membrane that separates the hydrogen electrode chamber and the oxygen electrode chamber.

### <Electrolyzer for Organic Hydride Synthesis>

The ion exchange membrane of the present embodiment can be used in a variety of applications by use of the performance thereof. As one example of such applications, the membrane can be used as a constituting member of an electrolyzer for organic hydride synthesis. That is, the electrolyzer for organic hydride synthesis of the present embodiment comprises the ion exchange membrane of the present embodiment. The configuration of the electrolyzer for organic hydride synthesis of the present embodiment is not particularly limited as long as comprising the ion exchange membrane of the present embodiment, and is only required to have the same configuration as that of a known one except for the ion exchange membrane. The configuration is not limited to the following, and may be the same as that of Japanese Patent No. 6782089, for example. Specifically, except that the ion exchange membrane of the present embodiment is employed instead of the substrate membrane described in the literature, the configuration described in the literature can be employed. More specifically, the electrolyzer for organic hydride synthesis of the present embodiment can comprise, for example, a membrane electrode assembly comprising a catalyst layer and the ion exchange membrane of the present embodiment as a substrate membrane that is non-conductive and porous and is in contact with the catalyst layer, and an anode/a cathode.

### EXAMPLES

Hereinafter, the present embodiment will be described further in detail based on examples. The present embodiment is not intended to be limited to these examples.

### [Evaluation Method]

### (Basis Weight)

The basis weight of the glass fiber M_{g} (g m⁻²) and the basis weight of the ion exchange membrane M_{comp} (g m⁻²) were each determined by dividing the mass of each sample cut into a size of 100×100 mm by the area of the sample. The samples were preliminarily dried at 80° C. under reduced pressure overnight.

### (Density)

The density of the glass fiber ρ_{g} (g cm⁻³), the density of the PFSA ρₚ (g cm⁻³), and the density of the ion exchange membrane ρ_{comp} (g cm⁻³) were each measured using a dry-process automatic pycnometer AccuPyc II 1345 manufactured by Shimadzu Corporation at 25° C. The samples were preliminarily dried at 80° C. under reduced pressure overnight.

### (Thickness)

The thickness of the glass fiber and the ion exchange membrane was measured with a micrometer.

### (SiO₂ Content of Glass Fiber)

The SiO₂ content of the glass fiber was determined on the premise that Si detected by X-ray fluorescence spectroscopy corresponds to SiO₂. X-ray fluorescence spectrometry was performed using a wavelength dispersive X-ray fluorescence spectrometer ZSX-100E (Rh bulb tube) manufactured by Rigaku Corporation. The glass fiber was cut into a round shape having a diameter of 30 mm and subjected to the measurement. The bulb tube voltage and the bulb tube current were set to 55 kV and 70 mA, respectively.

### (Fiber Diameter of Glass Fiber)

The fiber diameter of the glass fiber was determined by averaging measurements at 10 points randomly selected from a scanning electron microscope image obtained by observation at a magnification of 10000 times.

### (Tex Count)

Tex count is the mass of fiber per 1000 m, expressed as a value in units of grams. The Tex count of the glass fiber was determined as follows. Warp yarn and weft yarn were each removed from the glass fiber cut into a size of 100×100 mm by an operation under an optical microscope. From the mass of the removed warp yarn and weft yarn of 100 mm in length, the Tex count of each of the yarns were determined, and the average value of these was taken as the Tex count of the glass fiber.

### (Number of Filaments)

The number of filaments of the glass fiber was determined from an optical microscope images of the warp yarn and weft yarn obtained by observation at a magnification of 50 times. The number of the filaments of the warp yarn and weft yarn was the same in any glass fiber.

(Ion Equivalent of Perfluorocarbon Sulfonic Acid Polymer (PFSA) EW (g eq⁻¹))

The EW of the PFSA was measured on a membrane prepared by casting a polymer solution. 25 mg of the PFSA membrane was added to 50 mL of a saturated NaCl aqueous solution and stirred at 25° C. for 10 minutes. Phenolphthalein as an indicator was added to this saturated NaCl aqueous solution, and the solution was subjected to neutralization titration using a 0.01 N NaOH aqueous solution. The Na salt-type PFSA membrane collected was washed with ion exchange water, then dried under reduced pressure, and weighed. The ion equivalent EW (g eq⁻¹) was determined from the equivalent of NaOH required for the neutralization M (mmol) and the mass of the Na salt-type PFSA membrane W (mg) by the following expression.

$$E W = \frac{W}{M} - 22$$

### (Volume Fraction of Glass Fiber in Ion Exchange Membrane f_{g} (Vol %))

The volume fraction of the glass fiber in the ion exchange membrane f_{g} (vol %) was determined by the following expression.

$${f}_{g} = \frac{{M}_{g} {ρ}_{comp}}{{M}_{comp} {ρ}_{g}} \times 100$$

### (Volume Fraction of PFSA in Ion Exchange Membrane fₚ (Vol %))

The volume fraction of the PFSA in the ion exchange membrane fₚ (vol %) was determined by the following expression.

$${f}_{p} = \frac{( {M}_{comp} - {M}_{g} ) {ρ}_{comp}}{{M}_{comp} {ρ}_{p}} \times 100$$

### (Volume Fraction of Voids in Ion Exchange Membrane fᵥ (Vol %))

The volume fraction of voids in the ion exchange membrane fᵥ (vol %) was determined by the following expression.

fᵥ=100−f_{g}−fₚ

### (Proton Conductivity)

The proton conductivity of the ion exchange membrane was measured using a membrane resistance measurement system MTS740 manufactured by Scribner Associates Inc. under a humidified air atmosphere of a temperature of 80° C., a relative humidity of 90%, and a pressure of 101 kPa. The ion exchange membrane was cut into a size of 20 mm×20 mm, and the cut membrane was pressed into contact with two electrodes made of carbon fiber paper in a size of 15 mm×15 mm. The specimen was exposed to the temperature, relative humidity, and pressure described above for 0.5 hours. Then, the complex impedance was measured while alternating current amplitudes having an amplitude of 10 mV was applied while logarithmic sweeping was performed at a frequency from 10 kHz to 10 mHz. The proton conductivity σ (Scm⁻¹) was determined from the value of the real part of the complex impedance Z′ (ohm) at a frequency of 1 kHz, the electrode area A (cm²), and the initial thickness of the ion exchange membrane t (cm) by the following expression.

$$o = \frac{t}{{Z}^{′} A}$$

Separately, the proton conductivity of the specimen was determined in the same manner after exposed under a humidified air atmosphere of a temperature of 80° C., a relative humidity of 90%, and a pressure of 101 kPa for 100 hours.

### (Tensile Strength)

The tensile strength of the ion exchange membrane was measured by a universal material tester 34SC-5 manufactured by Instron Inc., equipped with a dedicated constant temperature and humidity chamber and fitted with a load cell of 1 kN. The ion exchange membrane was cut into a strip of 10 mm in width×80 mm in length. The thickness of the strip was measured at 5 points, and the average of the measurements was determined. The strip specimen was gripped so as to allow the gauge length to be 50 mm. With the temperature and the relative humidity of the constant temperature and humidity chamber set to 25° C. and 90%, respectively, the specimen was exposed to the environment for about 30 minutes. Then, while the cross head was moved at 10 mm min⁻¹, measurement for a load-displacement curve was performed. The load at break was divided by the initial cross-sectional area of the specimen to determine the tensile strength.

### [Production of Ion Exchange Membrane]

### Example 1

A woven fabric having a basis weight of 8.6 (g m⁻²) and a thickness of 11 μm was used as a reinforcing material, which fabric was obtained by plain-weaving glass fiber bundles that were made of Q glass having a SiO₂ content of 99.9% by mass and a density of 2.20 (g cm⁻³) and had a fiber diameter of 3.8 μm, a number of filaments of 50, and a Tex count of 1.25 Tex. Meanwhile, a Nafion solution (PN 663492) manufactured by Sigma-Aldrich Co. LLC was used as the PFSA. The composition of the solution was comprised of 22% by mass of PFSA, 44% by mass of 1-propanol, and 34% by mass of water. The EW of the PFSA was 1100 (g eq⁻¹).

The membrane was formed using a blade coater that can control the interval between the substrate and the blade. First, the PFSA solution was spread on Kapton as the substrate using a blade coater with the interval set to 150 μm. This was heat-dried at 80° C. to obtain a PFSA layer having a thickness of about 15 μm. Next, the glass fiber was layered on this PFSA layer, and the PFSA solution was spread further thereon with a blade coater having an interval of 250 μm. This was heat-dried at 80° C. to obtain a laminate of the PFSA and glass fiber having a thickness of about 40 μm. Lastly, this laminate was thermal-treated at 190° C. for 20 minutes and then released from the Kapton to obtain an ion exchange membrane.

### Example 2

An ion exchange membrane was produced in the same manner as in Example 1 except that a woven fabric having a basis weight of 8.3 (g m⁻²) and a thickness of 12 μm was used as the reinforcing material, which fabric was obtained by plain-weaving glass fibers that were made of Q glass and had a fiber diameter of 2.8 μm, a number of filaments of 50, and a Tex count of 0.68 Tex.

### Example 3

An ion exchange membrane was produced in the same manner as in Example 1 except that a woven fabric having a basis weight of 9.1 (g m⁻²) and a thickness of 14 μm was used as the reinforcing material, which fabric was obtained by plain-weaving glass fibers that were made of Q glass and had a fiber diameter of 4.9 μm, a number of filaments of 50, and a Tex count of 2.07 Tex.

### Example 4

An ion exchange membrane was produced in the same manner as in Example 1 except that a woven fabric having a basis weight of 7.8 (g m⁻²) and a thickness of 11 μm was used as the reinforcing material, which fabric was obtained by plain-weaving glass fibers that were made of Q glass and had a fiber diameter of 3.8 μm, a number of filaments of 100, and a Tex count of 2.49 Tex.

### Example 5

An ion exchange membrane was produced in the same manner as in Example 1 except that a woven fabric having a basis weight of 10.5 (g m⁻²) and a thickness of 14 μm was used as the reinforcing material, which fabric was obtained by plain-weaving glass fibers that were made of Q glass and had a fiber diameter of 3.8 μm, a number of filaments of 25, and a Tex count of 0.62 Tex.

### Example 6

An ion exchange membrane was produced in the same manner as in Example 1 except that a woven fabric having a basis weight of 9.8 (g m⁻²) and a thickness of 13 μm was used as the reinforcing material, which fabric was obtained by twill-weaving glass fibers that were made of Q glass and had a fiber diameter of 3.8 μm, a number of filaments of 50, and a Tex count of 1.25 Tex.

### Example 7

An ion exchange membrane was produced in the same manner as in Example 1 except that a woven fabric having a basis weight of 7.9 (g m⁻²) and a thickness of 12 μm was used as the reinforcing material, which fabric was obtained by satin-weaving glass fibers that were made of Q glass and had a fiber diameter of 3.8 μm, a number of filaments of 50, and a Tex count of 1.25 Tex.

### Example 8

An ion exchange membrane was produced in the same manner as in Example 1 except that Aquivion D79-25BS (PN 802565) manufactured by Sigma-Aldrich Co. LLC was used as the PFSA solution and that the intervals for the bar coater on coating for the first time and the second time were set to 132 μm and 220 μm, respectively. The composition of the PFSA solution was comprised of 24% by mass of the PFSA and 76% by mass of water. The EW of the PFSA polymer was 790 (g eq⁻¹).

### Comparative Example 1

An ion exchange membrane was produced in the same manner as in Example 1 except that a woven fabric having a basis weight of 8.8 (g m⁻²) and a thickness of 12 μm was used as the reinforcing material, which fabric was obtained by plain-weaving glass fibers that were made of E glass having a SiO₂ content of 54.5% by mass and had a fiber diameter of 4.0 μm, a number of filaments of 50, and a Tex count of 1.62 Tex.

### Comparative Example 2

An ion exchange membrane was produced in the same manner as in Example 1 except that a woven fabric having a basis weight of 8.5 (g m⁻²) and a thickness of 10 μm was used as the reinforcing material, which fabric was obtained by plain-weaving glass fibers that were made of D glass having a SiO₂ content of 74.0% by mass and had a fiber diameter of 3.9 μm, a number of filaments of 50, and a Tex count of 1.26 Tex.

The details and evaluation results of Examples and Comparative Examples are shown in Table 1 below.

TABLE 1

| | | | | | | | | | | Compar- | Compar- |
|---|---|---|---|---|---|---|---|---|---|---|---|
| | | Exam- | Exam- | Exam- | Exam- | Exam- | Exam- | Exam- | Exam- | ative | ative |
| | | ple 1 | ple 2 | ple 3 | ple 4 | ple 5 | ple 6 | ple 7 | ple 8 | Example 1 | Example 2 |
| Glass | Glass type | Q glass | Q glass | Q glass | Q glass | Q glass | Q glass | Q glass | Q glass | E glass | D glass |
| fiber | SiO2 content (% by | 99.9 | 99.9 | 99.9 | 99.9 | 99.9 | 99.9 | 99.9 | 99.9 | 54.5 | 74.0 |
| woven | mass) | | | | | | | | | | |
| fabric | Glass fiber density | 2.20 | 2.20 | 2.20 | 2.20 | 2.20 | 2.20 | 2.20 | 2.20 | 2.58 | 2.11 |
| | (g cm⁻³) | | | | | | | | | | |
| | Fiber diameter (μm) | 3.8 | 2.8 | 4.9 | 3.8 | 3.8 | 3.8 | 3.8 | 3.8 | 4.0 | 3.9 |
| | Number of filaments | 50 | 50 | 50 | 100 | 25 | 50 | 50 | 50 | 50.0 | 50 |
| | Tex count (tex) | 1.25 | 0.68 | 2.07 | 2.49 | 0.62 | 1.25 | 1.25 | 1.25 | 1.62 | 1.26 |
| | Basis weight (g m⁻²) | 8.6 | 8.3 | 9.1 | 7.8 | 10.5 | 9.8 | 7.9 | 8.6 | 8.8 | 8.5 |
| | Thickness (μm) | 11 | 12 | 14 | 11 | 14 | 13 | 12 | 11 | 12 | 10 |
| | Weaving method | Plain | Plain | Plain | Plain | Plain | Twill | Satin | Plain | Plain | Plain |
| | | weaving | weaving | weaving | weaving | weaving | weaving | weaving | weaving | weaving | weaving |
| Ion | EW (g eq⁻¹) | 1100 | 1100 | 1100 | 1100 | 1100 | 1100 | 1100 | 790 | 1100 | 1100 |
| exchange | Density (g cm⁻³) | 2.05 | 2.05 | 2.05 | 2.05 | 2.05 | 2.05 | 2.05 | 2.12 | 2.05 | 2.05 |
| resin | | | | | | | | | | | |
| Physical | Membrane thickness | 40 | 40 | 40 | 40 | 40 | 40 | 40 | 40 | 40 | 40 |
| properties | (μm) | | | | | | | | | | |
| | Basis weight (g m⁻²) | 82 | 82 | 82 | 82 | 82 | 82 | 82 | 85 | 83 | 82 |
| | Thickness (μm) | 2.05 | 2.05 | 2.06 | 2.06 | 2.06 | 2.05 | 2.06 | 2.12 | 2.08 | 2.04 |
| | Volume fraction of | 9.8 | 9.4 | 10.3 | 8.9 | 11.9 | 11.1 | 9.0 | 9.8 | 8.5 | 10.1 |
| | glass fiber woven | | | | | | | | | | |
| | fabric (vol %) | | | | | | | | | | |
| | Volume fraction of | 89.5 | 89.7 | 89.4 | 90.7 | 87.5 | 88.1 | 90.6 | 89.6 | 90.8 | 89.3 |
| | PFSA polymer (vol %) | | | | | | | | | | |
| | Volume fraction of | 0.7 | 0.9 | 0.3 | 0.4 | 0.6 | 0.8 | 0.4 | 0.6 | 0.7 | 0.6 |
| | voids | | | | | | | | | | |
| | Proton conductivity | 134 | 135 | 134 | 136 | 131 | 132 | 136 | 179 | 136 | 134 |
| | (after 0.5 hours; | | | | | | | | | | |
| | mS cm⁻¹) | | | | | | | | | | |
| | Proton conductivity | 134 | 134 | 134 | 136 | 131 | 132 | 136 | 179 | 74 | 99 |
| | (after 100 hours; | | | | | | | | | | |
| | mS cm⁻¹) | | | | | | | | | | |
| | Tensile strength (MPa) | 353 | 341 | 373 | 322 | 427 | 400 | 326 | 353 | 311 | 363 |

The present application claims the priority based on a Japanese Patent Application filed on Aug. 11, 2011 (Japanese Patent Application No. 2021-131220) and a Japanese Patent Application filed on Jun. 13, 2022 (Japanese Patent Application No. 2022-095231), the contents of which are hereby incorporated by reference.

1. An ion exchange membrane comprising:
an electrolyte comprising a perfluorocarbon sulfonic acid polymer; and
glass fiber having a SiO₂ content of 99.9% by mass or more.

2. The ion exchange membrane according to claim 1, wherein a basis weight of the glass fiber is 3.0 g/m² or more and 15 g/m² or less.

3. The ion exchange membrane according to claim 1, wherein a fiber diameter of the glass fiber is 1 μm or more and 10 μm or less.

4. The ion exchange membrane according to claim 1, wherein a Tex count of the glass fiber is 0.05 Tex or more and 10 Tex or less.

5. A membrane electrode assembly comprising the ion exchange membrane according to claim 1, and a catalyst layer disposed on at least one surface of the ion exchange membrane.

6. A fuel cell comprising the membrane electrode assembly according to claim 5.

7. A redox flow secondary battery comprising the ion exchange membrane according to claim 1.

8. A water electrolyzer comprising the ion exchange membrane according to claim 1.

9. An electrolyzer for organic hydride synthesis comprising the ion exchange membrane according to claim 1.
